(19) United States
(12) Patent Application Publication
(10) Pub. No.: US 2016/0065534 A1
(43) Pub. Date: Mar. 3, 2016

(54) SYSTEM FOR CORRELATION OF DOMAIN NAMES

(71) Applicant: Nominum, Inc., Redwood City, CA (US)

(72) Inventors: Hongliang Liu, Campbell, CA (US); Mikael Kullberg, Stockholm (SE); Yuriy Yuzifovich, Los Gatos, CA (US); James Paugh, San Carlos, CA (US); Robert S. Wilbourn, Palo Alto, CA (US)

(21) Appl. No.: 14/937,616

(22) Filed: Nov. 10, 2015

Related U.S. Application Data
(63) Continuation-in-part of application No. 13/177,504, filed on Jul. 6, 2011, now Pat. No. 9,185,127.

(51) Int. Cl. H04L 29/12; G06F 17/30

(52) U.S. Cl. CPC H04L 61/1511; G06F 17/30864; G06F 17/30554; G06F 17/30601

(57) ABSTRACT

Provided are methods and systems for correlation of domain names. An example method includes receiving Domain Name System (DNS) data associated with a plurality of domain names, generating multidimensional vectors based on the DNS data such that each of the domain names is associated with one of the multidimensional vectors, calculating similarity scores for each pair of the plurality of domain names based on comparison of corresponding multidimensional vectors, and clustering one or more sets of domain names selected from the plurality of domain names based on the similarity scores and such that a difference between the similarity scores corresponding to each pair of the domain names in each of clusters is below a predetermined threshold.

### CROSS-REFERENCE TO RELATED APPLICATIONS

The present application is a continuation-in-part of, and claims the priority benefit of, U.S. patent application Ser. No. 13/177,504 filed on Jul. 6, 2011, entitled “Network Protection Service,” now U.S. Pat. No. 9,185,127 issued on Nov. 10, 2015, the disclosure of which is incorporated herein by reference in its entirety for all purposes.

### TECHNICAL FIELD

This disclosure relates generally to computer networking and processing of Domain Name System (DNS) queries. More specifically, this disclosure relates to systems and methods for correlating domain names using multidimensional vectors representing domain names.

### BACKGROUND

In computer networking, domain names can help in locating data or a service. A domain name is formed according to certain rules and can be registered with a Domain Name system (DNS) authority. Domain names can be used for various naming and addressing purposes. In general, a domain name is associated with a resource such as a personal computer, a server hosting a web site, or a web service that can be identified by an Internet Protocol (IP) address.

Some web services, Internet Service Providers (ISPs), and software products, such as computer antivirus applications, may attempt to analyze a domain name to determine security threats associated with the underlying resource. However, such analysis can be a difficult task. For example, it may be obvious to a human that the domain name “www.sfgiants.com” refers to the “San Francisco Giants” baseball team, while the domain name “www.redsox.com” refers to the “Red Sox” baseball team, and that both of these domain names relate to baseball teams. However, semantics of these domain names, per se, carry little information concerning their correlation. Likewise, similarly-looking domain names can be used in completely different ways. For example, the domain name “www.hotmail.com” refers to a legitimate email service, while “www.hatmail.com” may potentially be used for malicious purposes such as phishing. Moreover, domain names used for malicious purposes can be intentionally obfuscated or machine-generated, such as, for example, “11ec95ecebdd432199.tk,” which hinders any analysis of semantic correlations between domains based on the domain names alone.

There exist solutions for analyzing correlations between domain names. Some existing solutions include calculation and normalization of conditional probabilities associated with domain names using domain name sequences retrieved from logs. However, such calculating of conditional probabilities is computationally expensive and requires large storage capacities.

Other existing solutions involve crawling websites corresponding to domain names for page content and detecting the presence of malicious content. However, the web crawling solutions require a cluster of machines and a fast internet connection. Other issues include retrieving content that differs from would be displayed and analyzing the downloaded content instead of corresponding domain names. Because some websites utilize RESTful Application Programming Interface (API) data, value of a single webpage source request without implementing a headless browser on a server for the web page to correctly render and produce the content is diminished. Finally, with the growth of Internet-of-Things (IoT) traffic, machine-to-machine (m2m) traffic, and web traffic produced by software, it is becoming increasingly difficult to utilize crawling methods due to the fact that domain names associated with IoT, m2m, and software may not render any HTML content.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The present disclosure is related to methods and systems for correlation of domain names. In some example embodiments, a method for correlation of domain names includes receiving DNS data associated with a plurality of domain names, generating multidimensional vectors based on the DNS data such that each of the domain names is associated with one of the multidimensional vectors, calculating similarity scores for each pair of the plurality of domain names based on comparison of corresponding multidimensional vectors, and clustering one or more sets of domain names selected from the plurality of domain names based on the similarity scores and such that a difference between the similarity scores corresponding to each pair of the domain names in each of clusters is below a predetermined threshold.

In some embodiments, the method may further include receiving a correlation request associated with a target domain name, determining that the target domain name is in a dictionary, which includes the plurality of domain names associated with the multidimensional vectors, and selecting a cluster associated with the target domain name based on the determination. If it is determined that the target domain name is not included in the dictionary, the method proceeds with ascertaining DNS data associated with the target domain name, generating a multidimensional vector for the target domain name, calculating similarity scores between the multidimensional vector for the target domain name and the multidimensional vectors of the plurality of the domain names in the dictionary, and assigning the target domain name to a cluster based on the calculation.

The calculation of multidimensional vectors can be performed by a classifier, which can be trained using the DNS data. The DNS data can be associated with a plurality of DNS queries, and can include, for example, for each of the DNS queries, an IP address of a client generating a DNS request, a time stamp of the DNS request, a DNS query name, and a DNS query type. The classifier can be trained by performing a forward propagation process to obtain a dictionary of the domain names with corresponding multidimensional vectors.

In some embodiments, the method may further include grouping the DNS queries by IP addresses of clients, sorting the DNS queries by the time stamp, and/or filtering the DNS data by removing DNS queries of predetermined types. The predetermined types of DNS queries may include: DNS queries associated with malicious attacks, Address and Routing Parameter Area (ARPA) queries, and DNS queries that appear less than a predetermined number of times in the training data.

In some embodiments, the DNS data can be received by collecting DNS queries from multiple ISPs for a predetermined period of time. In some embodiments, the multidimensional vectors of the domain names provide numeric representation vectors that reflect semantic similarities between the domain names.

In some embodiments, the method further comprises selecting pairs of the plurality of domain names based on a skip-gram model and/or ranking two or more of the domain names in at least one of the clusters to create a ranked list of the domain names. Each of the clusters of the domain names can reflect operational behavior of the domain names in the cluster.

In certain embodiments, the method further comprises the steps of projecting the multidimensional vectors onto two-dimensional (2D) space by performing a dimension reduction technique, visualizing at least one of the clusters of the domain names via a user graphical interface by displaying graphical representations of the multidimensional vectors projected onto the 2D space. The visualization step may comprise displaying domain name maps such that each of the domain name maps has individual graphical representation such that the domain name maps are visually different from each other.

In certain embodiments, the method further comprises receiving DNS data associated with a plurality of domain names having trusted categorization data, generating multidimensional vectors for each of the domain names, receiving at least one domain name with no categorization data or having untrusted categorization data, generating a multidimensional vector of the at least one domain name with no categorization data or having untrusted categorization data, calculating similarity scores between the multidimensional vector of the at least one domain name with no categorization data or having untrusted categorization data and each of the multidimensional vectors associated with the domain names having trusted categorization data, and based on the similarity scores, assigning a category to the at least one domain name with no categorization data or having untrusted categorization data.

According to another aspect of this disclosure, there is provided a system comprising at least one processor and a memory storing processor-executable codes. The at least one processor is configured to implement the aforementioned method for data correlation of domain names.

According to yet another aspect of this disclosure, there is provided a non-transitory processor-readable medium having instructions stored thereon. When these instructions are executed by one or more processors, they cause the one or more processors to implement the above-described method for data correlation of domain names.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF DRAWINGS

Exemplary embodiments are illustrated by way of example and not limitation in the figures of the accompanying drawings, in which like references indicate similar elements.

FIG. 1 is a block diagram of an example computer network environment suitable for practicing methods for correlating domain names.

FIG. 2 is a flow chart of an example method for correlation of domain names.

FIG. 3 is a flow chart of another example method for correlation of domain names.

FIG. 4 is a flow chart of another example method for classifying (or re-classifying) of domain names.

FIG. 5 is a computer system that may be used to implement the methods for correlation of domain names.

### DETAILED DESCRIPTION

The technology disclosed herein is concerned with domain name analysis and correlation, which may overcome at least some drawbacks of existing solutions, including computational complexity, high storage demand, and ability to analyze web traffic generated by software. According to various embodiments of this disclosure, this technology is based on extracting certain semantic knowledge from DNS query history and using this knowledge to find correlations between domain names. An example approach can involve obtaining DNS data related to multiple DNS queries. The DNS queries can be collected from one or more ISPs, which can be located in multiple parts of the world. Each of the DNS queries is typically associated with a certain domain name. Therefore, the DNS data includes multiple domain names. The DNS data can also include data related to DNS data, such as, for example, an IP address of a client generating a DNS request, a time stamp of the DNS request, a DNS query name, and/or a DNS query type.

A classifier can be then trained using the DNS data by applying one or more machine-learning techniques. The classifier can further allow generating a multidimensional vector for each of the domain names from the DNS data. Using this approach, a domain name can be characterized by a multidimensional vector. Correlating domain names to respective multidimensional vectors can be referred to as a dictionary.

Once the classifier provides the dictionary, similarity scores can be calculated for one or more pairs of the domain names using a measure of similarities between corresponding multidimensional vectors. For example, a cosine similarity can be calculated that measures the cosine of the angle between two multidimensional vectors. The similarity scores further allow correlating the domain names, such as finding a semantic correlation. For example, domain names can be grouped or clustered such that each group or cluster represents domain names with similarities in certain characteristics. In some embodiments, a cluster can be created to include domain names, which have similarity scores higher than a predetermined threshold value. In other embodiments, a cluster can be created to include domain names, for which a difference between their respective similarity scores is below than a predetermined threshold value. The clustering may also involve other or additional techniques. For example, domain names within a cluster can be ranked, filtered, or organized in any other meaningful manner.

A system for correlating domain names according to this disclosure may have a wide range of applications. In one example, one or more domain names can be identified and clustered for a particular target domain name. In another example, a target domain name can be classified, re-classified, categorized, or re-categorized based on the results of correlation of the target domain name with a dictionary. In yet another example, new emerging command-and-control (C&C) server domains and/or amplification attack domains can be identified and clustered using particular DNS training data. In yet another example, the system also allows identifying and clustering DNS tunneling domains. In yet another example, advertisement-related domain names can be located and clustered by the system. In some examples, the system can identify malicious domain names or newly emerging suspicious domain names. It should be noted, however, that the system may have one or more further uses, which can be evident to those skilled in the art in view of this specification.

For purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

Furthermore, the term “DNS” shall mean Domain Name System representing a hierarchical distributed naming system for computers, servers, content, services, or any resource available via the Internet or private network. The term “domain name” shall be given its ordinary meaning such as a network address to identify the location a particular web resource, content, service, computer, server, and so forth. In certain embodiments, domain names can identify one or more IP addresses. The term “multidimensional vector” shall mean a numerical representation of certain properties associated with a domain name. In some embodiments, multidimensional vectors can be represented as a data array, matrix, or an algebraic vector of an N-dimensional space. The term “dictionary” can refer to a set of domain names matching corresponding multidimensional vectors. In certain embodiments, a dictionary can be used by a classifier. The term “classifier” can refer to a device, system module, software module, technique, process, or algorithm for performing statistical data classification using, for example, one or more machine-learning algorithms and/or heuristic methods.

Referring now to the drawings, various embodiments will be described, wherein like reference numerals represent like parts and assemblies throughout the several views. It should be noted that the reference to various embodiments does not limit the scope of the claims attached hereto. Additionally, any examples set forth in this specification are not intended to be limiting and merely set forth some of the many possible embodiments for the appended claims.

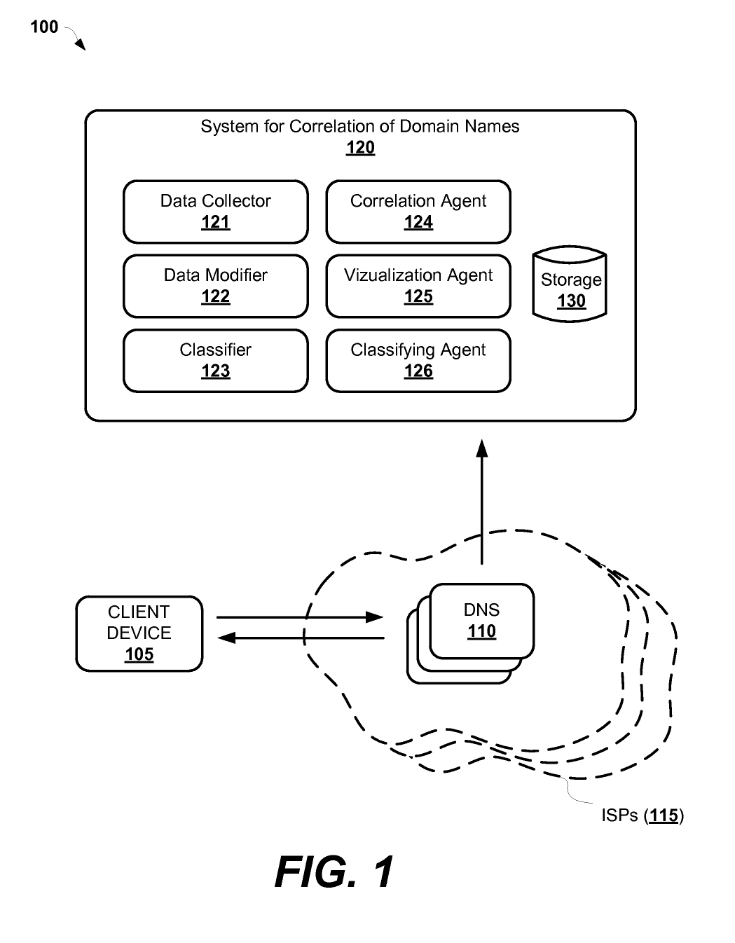

FIG. 1 shows a block diagram of an example computer network environment 100 suitable for practicing methods for correlating domain names as described herein. It should be noted, however, that the environment 100 is just one example environment provided for illustrative purposes and reasonable deviations are possible.

As shown in FIG. 1, there is provided a client device 105 (also referred herein to as “client” for simplicity). The client device 105 is generally any appropriate computing device having network functionalities allowing communicating under any existing protocols. Some examples of the client devices 105 include, but are not limited to, a computer (e.g., laptop computer, tablet computer, desktop computer), cellular phone, smart phone, gaming console, multimedia system, smart television device, set-top box, infotainment system, in-vehicle computing device, informational kiosk, robot, smart home computer, home appliance device, Internet-of-Things (IoT) device, software application, computer operating system, modem, router, and so forth. The environment 100 may include multiple client devices 105, but these are not shown for ease of understanding. The client devices 105 can include computers operated by users and also devices operated by a robot or software.

The client device 105 can make certain inquires via the computer network environment 100, such as, for example, a request to open a website in a browser, download a file from the Internet, access a web service via a software application, and so forth. The client query may include a DNS query associated with a domain name or a host name (e.g., “www.nominum.com”), which requires resolution to an IP address. The DNS query initiated by the client device 105 can be transmitted to a recursive DNS server, or simply, DNS 110, which can be associated with a particular ISP 115. For purposes of this patent document, the terms “DNS query,” “DNS inquiry,” and “DNS request” shall mean the same and therefore can be used interchangeably.

The DNS 100 can resolve the DNS query and returns an IP address associated matching the domain name. The IP address is then delivered to the client 105. In certain embodiments, the DNS query includes the following DNS data: an IP address of the client 105, a time stamp of the DNS inquiry, DNS query name (e.g., a domain name), and/or a DNS query type. The DNS data can be aggregated or stored in a cache of DNS 100.

Still referring to FIG. 1, there is shown a system for correlation of domain names 120 (also referred to as “system 120” for simplicity). The system 120 may be implemented on a server, a plurality of servers and provide a cloud-based domain correlation service. As shown in the figure, the system 120 includes a plurality of modules, which can refer to hardware modules (e.g., decision-making logic, dedicated logic, programmable logic, application-specific integrated circuit (ASIC)), software modules (e.g., software run on a general-purpose computer system or a dedicated machine, microcode, computer instructions), or a combination of both.

The system 120 includes a data collector 121 for receiving, acquiring, obtaining, or collecting DNS data from one or more DNS servers 110. The DNS data can be received from one or more ISPs 115. In certain embodiments, the data collector 121 can be configured to receive the DNS data from selected DNS servers 110. Similarly, the data collector 121 can be configured to receive DNS data from selected ISPs 115. The ISPs 115 can be located in one or more countries. The DNS data can be received by the data collector 121 in real time (i.e., live data streams are supplied to the data collector 121). In other embodiments, the data collector 121 can collect previously stored DNS data from DNS servers 110. In yet more embodiments, DNS data can be received by the data collector from non-DNS servers.

The data collector 121 can store the received DNS data to storage 130 such as a computer memory. In certain embodiments, the data collector 121 stores DNS data in fragments. Specifically, DNS data can include DNS queries collected during a predetermined period. The predetermined period can range from about 1 minute to about 24 hours, but there could be predetermined periods of different lengths. For example, DNS data can be stored in 10-second fragments, 1-minute fragments, 10-minute fragments, 1-hour fragments, 24-hour fragments, and so forth.

The system 120 can further include an optional data modifier 122 configured to pre-process the DNS data received and stored by the data collector 121. The pre-processing of the DNS data is optional and depends on particular application needs. In certain embodiments, the data modifier 122 can group DNS queries of DNS data by client IP address. In further embodiments, the data modifier 122 can sort or rank DNS queries of received DNS data by time stamps. In yet further embodiments, the data modifier 122 can sort DNS queries of received DNS data by a DNS query type (such as “A,” “AAAA,” “AFSDB,” “APL,” “DNAME,” “LOC,” “MX,” “SRV,” and so forth).

Furthermore, the data modifier 122 can perform filtering and/or cleaning DNS data by removing DNS queries of predetermined types. The predetermined types of DNS queries can include, for example, DNS queries associated with malicious attacks, DNS queries associated with phishing, DNS queries associated with malware, DNS queries associated with suspicious network resources or domains, and/or Address and Routing Parameter Area (ARPA) queries. In some embodiments, the data 122 can filter DNS data by removing same or similar DNS queries that appear less than a predetermined number of times in certain DNS data fragments. For example, all DNS queries that appear less than three times in the DNS data collected during one day (or any other time periods) can be removed from the DNS data. The filtering technique may allow reducing noise and random or unintended DNS queries.

In yet further embodiments, the data modifier 122 can perform pre-selection of DNS queries (in other words, a selection of domain names) for further processing. In one example, the selection of domain name pairs from DNS data can be based on a skip-gram model. Generally, a skip-gram model is a generalization of n-grams technique, in which the components need not be consecutive in the set under consideration, but may leave gaps that are skipped over. Formally, an n-gram is a consecutive subsequence of length n of some sequence of tokens w₁ . . . wₙ. A k-skip-n-gram is a length-n subsequence, where the components occur at a skip distance at most k from each other. For example, if the input to the model is a phrase “The rain in Spain falls mainly on the plain,” the set of 1-skip-2-grams includes all bigrams (2-grams) and also the subsequences “the in,” “rain Spain,” “in falls,” “Spain mainly,” “falls on,” “mainly the,” and “on plain.” Similarly to this text, the skip-gram technique can be applied to a set of domain names provided by the DNS data. In certain embodiments, the skip distance k can be in the range from about 1 to about 100.

The system 120 further includes a classifier 123 for processing DNS data received by data collector 121. In some embodiments, the classifier 123 can process pairs of domain names selected by the data modifier 122. Moreover, in some embodiments, the domain names supplied to the classifier can be grouped by client IP addresses. The classifier 123 can employ one or more “word2vec” (word-to-vector) algorithms and also one or more machine-learning algorithms to process the DNS data. The classifier 123 may need initial training before it is applied to target domain names. The training may produce a model associated with a dictionary. For example, the classifier 123 can receive a set of domain names from the DNS data as training input and produce multidimensional vectors as output, where each multidimensional vector corresponds to a numerical representation of the corresponding domain name. Accordingly, a set of multidimensional vectors of certain domain names represents semantic similarities among the domain names.

A forward propagation process can be further used by the trained classifier 123 to construct a dictionary of the domain names associated with their respective multidimensional vectors. The dictionary can be stored in the storage 130. The dictionary can be further used by the classifier 123 to generate multidimensional vectors of target domain names. In this process, the multidimensional vectors can be used as features in the machine-learning algorithm of the classifier 123. In some embodiments, the classifier 123 can apply a neighborhood size factor selected in the range from about 5 to about 100. The neighborhood size factor defines the number of domain names selected for training or processing by the classifier 123. Thus, the classifier 123 can convert input representation of domain names or a list of domains names into vector representations such as a high-dimensional vector space that corresponds to the DNS data applied to the classifier 123.

The system 120 further includes a correlation agent 124 for calculating similarity scores of the domain names based on the multidimensional vectors and for clustering (grouping) certain domain names based on the similarity scores. The similarity scores and the multidimensional vectors can be stored in the storage 130.

In certain embodiments, the similarity among domain names can be calculated by the correlation agent 124 using algebraic similarity between multidimensional vectors. For example, cosine similarity between two or more multidimensional vectors can be calculated by the correlation agent 124. The similarity scores can be then normalized. Thus, each pair of domain names can have a similarity score from 0 to 1. Accordingly, each pair of domain name from the dictionary can be assigned a respective similarity score.

The correlation agent 124 can be further configured to cluster or group those domain name pairs having similarity scores higher than a predetermined threshold value. In other words, the correlation agent 124 can group one or more set of domain names such that a difference between the similarity scores corresponding to each pair of the domain names is below a predetermined threshold. The resulting clusters or groups of similar domain names can be further sorted, ranked, and/or filtered. For example, domain names in one cluster can be sorted by a similarity score. In another example, domain names in a cluster are ranked by a difference value. The generated clusters of domain names can be then output to a client, DNS server, ISP, analytics software, and so forth.

By varying settings or operation parameters of the classifier 123 and the correlation agent 124, clusters of certain domain names with same or similar operational behavior can be generated. In other words, a cluster can include domain names, which are associated with certain known malicious resources or certain malicious activity, or certain botnet activity, or certain unwanted advertisement content activity, and so forth.

Thus, the present technology allows for identifying groups of clusters of domain names in the high-dimensional vector space that have either a close semantic context or generated by the same software, which may include malware. This technology can allow grouping same or similar domain names by their pair-wise similarities.

Still referring to FIG. 1, the system 120 further includes an optional visualization agent 125. In some embodiments, the visualization agent 125 is configured to project multidimensional vectors of domain names to two-dimensional (2D) space by performing a dimension reduction technique. Some examples of the dimension reduction technique can include one or more of the following: Principal Component Analysis (PCA), Probabilistic PCA, Factor Analysis (FA), Classical multidimensional scaling (MDS), Sammon mapping, Linear Discriminant Analysis (LDA), Isomap, Landmark Isomap, Local Linear Embedding (LLE), Laplacian Eigenmaps, Hessian LLE, Local Tangent Space Alignment (LTSA), Conformal Eigenmaps (extension of LLE), Maximum Variance Unfolding (extension of LLE), Landmark MVU (LandmarkMVU), Fast Maximum Variance Unfolding (FastMVU), Kernel PCA, Generalized Discriminant Analysis (GDA), Diffusion maps, Neighborhood Preserving Embedding (NPE), Locality Preserving Projection (LPP), Linear Local Tangent Space Alignment (LLTSA), Stochastic Proximity Embedding (SPE), Deep autoencoders (using denoising autoencoder pretraining), Local Linear Coordination (LLC), Manifold charting, Coordinated Factor Analysis (CFA), Gaussian Process Latent Variable Model (GPLVM), Stochastic Neighbor Embedding (SNE), Symmetric SNE, t-Distributed Stochastic Neighbor Embedding (t-SNE), Neighborhood Components Analysis (NCA), Maximally Collapsing Metric Learning (MCML), and Large-Margin Nearest Neighbor (LMNN).

The visualization agent 125 can be further configured to visualize one or more clusters of domain names via a user graphical interface (GUI) by displaying or causing to display graphical representations of multidimensional vectors projected onto the 2D space. For example, the visualization agent 125 can cause displaying clusters of domain names in certain categories, such as pornography, finance, travel, sports, and so forth. In some embodiments, the visualization of clusters includes displaying via a GUI domain name maps. Each of the domain name maps can have individual graphical representation such that the domain name maps are visually different from each other. For example, one cluster of domain names representing finance can be colored in a first color, another cluster of domain names representing sports can be colored in a second color, yet another one cluster of domain names representing the travel industry can be colored in a third color, and so forth.

In certain embodiments, the visualization agent 125 can support interactive visualization of domain name clusters such that an operator can apply various dimensionality reduction parameters and explore clusters, both in a 2D space and in a three-dimensional (3D) space, with the ability to zoom-in or zoom-out to get additional information about each individual domain name or cluster as a whole.

Still referring to FIG. 1, the system 120 can further include an optional classifying agent 126. The classifying agent 126 can be configured to classify, re-classify, categorize, or re-categorize domain names. For example, if a particular domain name is not previously classified (i.e., as relating to finance, travel, sports, or other fields), the classifying agent 126 can assign a proper classification to the domain name based on similarity scores calculated for this particular domain name and a dictionary. Similarly, if a particular domain name was previously classified incorrectly, the classifying agent 126 can correctly reclassify the domain name based on similarity scores calculated for the domain name and a dictionary.

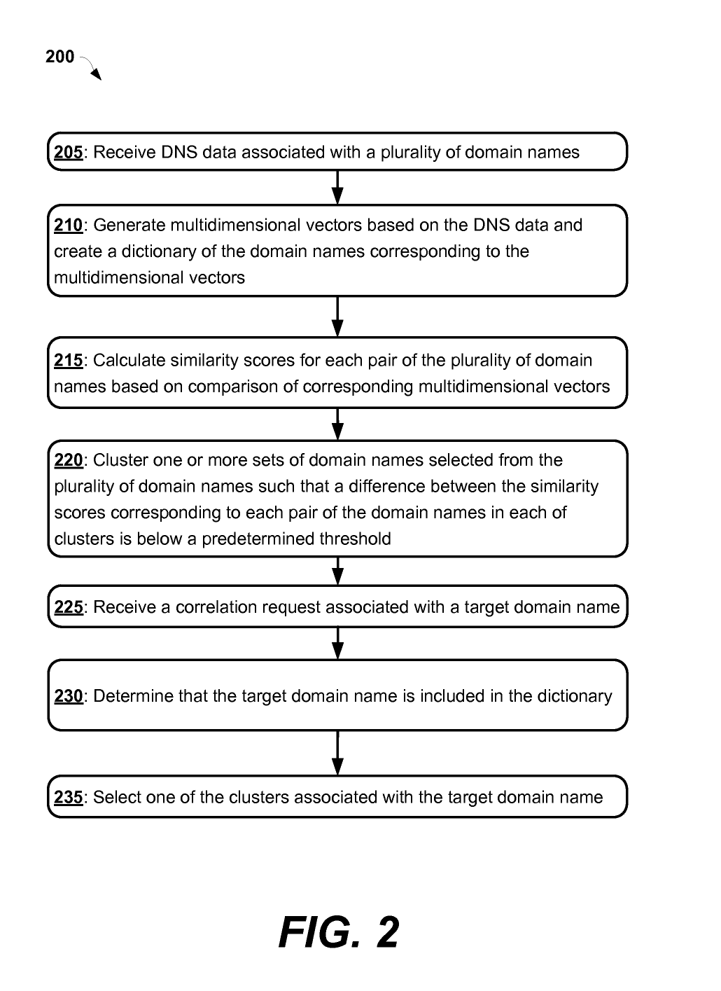

FIG. 2 is a flow chart of an example method 200 for correlation of domain names, according to some embodiments. The method 200 may be performed by processing logic that may comprise hardware (e.g., decision-making logic, dedicated logic, programmable logic, and microcode), software (such as software run on a general-purpose computer system or a dedicated machine), or a combination of both. In one example embodiment, the processing logic is included in one or more components of the system 120 described above with reference to FIG. 1. Notably, the steps recited below may be implemented in an order different than described and shown in the figure. Moreover, the method 200 may have additional steps not shown herein, but which can be evident from the present disclosure to those skilled in the art. The method 200 may also have fewer steps than outlined below and shown in FIG. 2.

The method 200 for correlation of domain names may commence at operation 205 with the data collector 121 receiving DNS data associated with a plurality of domain names. The DNS data can be used as a training data set for the classifier 123. The DNS data include multiple domain names and also DNS related information (e.g., client IP addresses).

At operation 210, the classifier 123 can generate multidimensional vectors based on the DNS data such that each of the domain names is associated with one of the multidimensional vectors. The classifier 123 can create a dictionary of the domain names corresponding to respective multidimensional vectors. At operation 215, the correlation agent 124 can calculate similarity scores for each pair of the plurality of domain names based on comparison of corresponding multidimensional vectors. At operation 220, the correlation agent 124 can cluster one or more sets of domain names selected from the plurality of domain names such that a difference between the similarity scores corresponding to each pair of the domain names in each of clusters is below a predetermined threshold.

At operation 225, the system 120 can receives a correlation request from a software application or a client. The correlation request can include a target domain name. At operation 230, the system 120 determines that the target domain name is included in the dictionary. Subsequently, at operation 235, the correlation agent 124 selects one of the clusters associated with the target domain name.

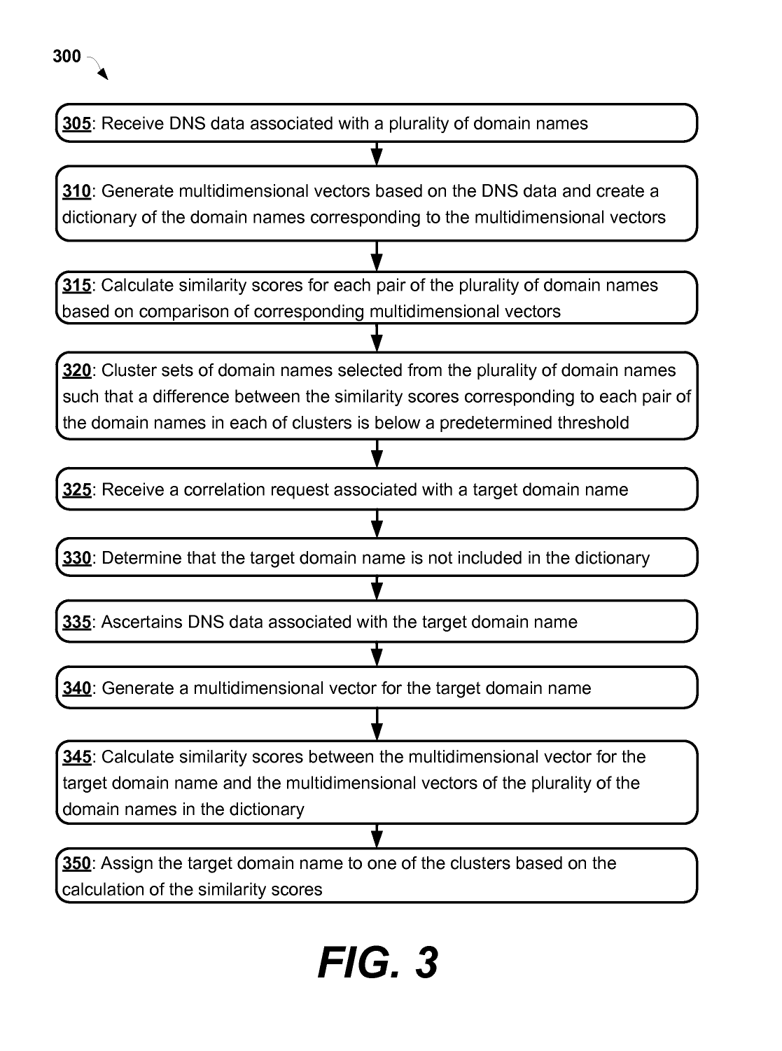

FIG. 3 is a flow chart of another example method 300 for correlation of domain names, according to some embodiments. The method 300 can be performed by processing logic that may comprise hardware (e.g., decision-making logic, dedicated logic, programmable logic, and microcode), software (such as software run on a general-purpose computer system or a dedicated machine), or a combination of both. In one example embodiment, the processing logic resides in one or more components of the system 120 described above with reference to FIG. 1. Notably, the steps recited below may be implemented in an order different than described and shown in the figure. Moreover, the method 300 may have additional steps not shown herein, but which can be evident to those skilled in the art from the present disclosure. The method 300 may also have fewer steps than outlined below and shown in FIG. 3.

The method 300 for correlation of domain names may commence at operation 305 with the data collector 121 receiving DNS data associated with a plurality of domain names. The DNS data can be used as a training data set for the classifier 123. The DNS data include multiple domain names and also DNS related information (e.g., client IP addresses).

At operation 310, the classifier 123 can generate multidimensional vectors based on the DNS data such that each of the domain names is associated with one of the multidimensional vectors. The classifier 123 can create a dictionary of the domain names corresponding to their respective multidimensional vectors. At operation 315, the correlation agent 124 can calculate similarity scores for each pair of the plurality of domain names based on a comparison of corresponding multidimensional vectors.

At operation 320, the correlation agent 124 can cluster one or more sets of domain names selected from the plurality of domain names such that a difference between the similarity scores corresponding to each pair of the domain names in each of clusters is below a predetermined threshold. At operation 325, the system 120 can receive a correlation request associated with a target domain name. At operation 330, the system 120 can determine that the target domain name is not included in the dictionary.

At operation 335, the data collector 121 can ascertain DNS data associated with the target domain name. At operation 340, the classifier 123 generates a multidimensional vector for the target domain name. At operation 345, the correlation agent 124 calculates similarity scores between the multidimensional vector for the target domain name and the multidimensional vectors of the plurality of the domain names in the dictionary. At operation 350, the correlation agent 124 assigns the target domain name to one of the clusters based on the calculation of the similarity scores.

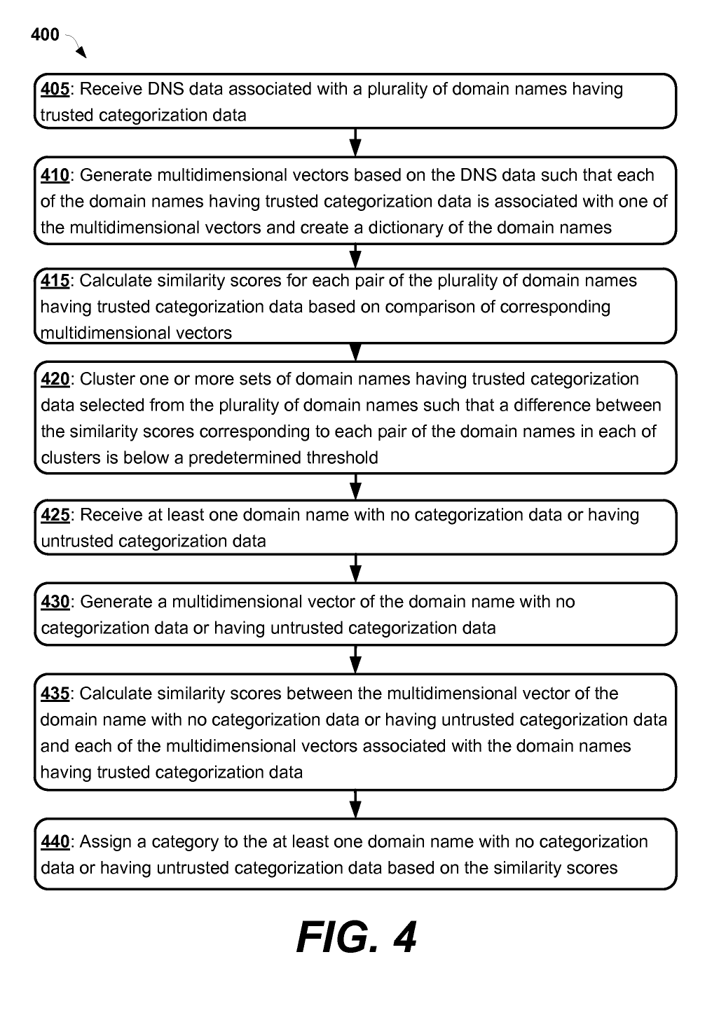

FIG. 4 is a flow chart of another example method 400 for classifying (or re-classifying) of domain names, according to some embodiments. The method 400 may be performed by processing logic that may comprise hardware (e.g., decision-making logic, dedicated logic, programmable logic, and microcode), software (such as software run on a general-purpose computer system or a dedicated machine), or a combination of both. In one example embodiment, the processing logic resides at one or more components of the system 120 described above with reference to FIG. 1. Notably, the steps recited below may be implemented in an order different than the order described and shown in the figure. Moreover, the method 400 may have additional steps not shown herein, but which can be evident to those skilled in the art from the present disclosure. The method 400 may also have fewer steps than outlined below and shown in FIG. 4.

Generally, domain categorization lists provided by third-parties can have inaccurate category information. For example, some pornography sites can be categorized as “Computer Technology” instead of “Pornography.” By applying the following method 400 which uses a set of domains with reliable categorizations (i.e., “ground truth”) and comparing the similarity of a new unknown domain name to the ground truth, the method can determine whether the new domain name is mis-categorized and facilitate its re-categorization. Alternatively, the method 400 may facilitate categorizing some websites (domain names) that have not been previously categorized.

The method 400 for classifying domain names may commence at operation 405 with the data collector 121 receiving DNS data associated with a plurality of domain names having trusted categorization data. The DNS data can be used as a training data set for the classifier 123. The DNS data include multiple domain names and also DNS related information (e.g., client IP addresses).

At operation 410, the classifier 123 generates multidimensional vectors based on the DNS data such that each of the domain names having trusted categorization data is associated with one of the multidimensional vectors. The classifier 123 can create a dictionary of the domain names corresponding to their respective multidimensional vectors.

At operation 415, the correlation agent 124 can calculate similarity scores for each pair of the plurality of domain names having trusted categorization data based on a comparison of corresponding multidimensional vectors. At operation 420, the correlation agent 124 clusters one or more sets of domain names having trusted categorization data selected from the plurality of domain names such that a difference between the similarity scores corresponding to each pair of the domain names in each of clusters is below a predetermined threshold.

At operation 425, the data collector 121 receives at least one domain name with no categorization data or having untrusted categorization data. At operation 430, the classifier 123 generates a multidimensional vector of the domain name with no categorization data or having untrusted categorization data. At operation 435, the correlation agent 124 can calculate similarity scores between the multidimensional vector of the domain name with no categorization data or having untrusted categorization data and each of the multidimensional vectors associated with the domain names having trusted categorization data. At operation 440, the correlation agent 124 can assign a category to the at least one domain name with no categorization data or having untrusted categorization data based on the similarity scores.

In some example embodiments, a cross-validation method can be used for determining of re-categorization accuracy. For example, a sample selection of categories “Pornography,” “Sports,” “Finance,” and “Travel” can be selected by the system 120 for determining their categorization accuracy. The system 120 can further acquire daily DNS data from one or more ISPs 115. Furthermore, the system can filter domain names in the received DNS data based on a predetermined rule and train the classifier 123 to generate clusters as using techniques discussed above, where each of the clusters can relate to a particular category.

The cross-validation technique may include the steps of random partitioning of each category (for example, 5-fold random partition), using one part as a validation set, while the rest of the parts are used as a “ground truth,” calculating the algebraic differences between multidimensional vectors of the validation set and multidimensional vectors of the “ground truth” set. Furthermore, the system 120 can assign the most similar category to each domain name of the validation set. Additionally, the system 120 can evaluate the accuracy of the categorization. Specifically, the system 120 can determine how many domain names are mis-categorized by calculating a true positive value and a false positive value, and determine how many domain names can obtain correct categorization. The evaluation can be based on a precision and recall technique.

The following description provides some use case examples for the methods described above.

### EXAMPLE 1

The system and method of correlation of domain names described herein was used to identify a plurality of domain names which presumably relate to malicious botnet domains. Here, a confirmed botnet domain name “c850ab673ef0eaf6406b34194c2cce12d9.hk” was used as an input to the trained classifier 123. After applying the method for correlation of domain names as described herein, the generated output was a cluster of the following domain names having the similarity score higher than 0.95:

TABLE 1

| Domain name | Similarity Score |
|---|---|
| s7d6696d6c92b6a59097f709a13d151448.hk | 0.98 |
| t1a34d607fcb667812ba7cb8650ccd8ed8.cn | 0.97 |
| w2bf5eb81e9a23893ecf3a0aeba6d9cbd9.to | 0.96 |
| h0e671d6d112a19a79f5ed5c36b3a8d695.so | 0.96 |
| le934f92b138cca705336680fc935a8cf5.cn | 0.95 |
| e62654c2538ffe595099524dad645bc2e5.tk | 0.95 |
| v60e8b91a3071b70892c9ae7e8d0be0ade.so | 0.95 |

### EXAMPLE 2

The system and method of correlation of domain names described herein was used to identify a plurality of suspicious domain names, which may relate to a malicious activity or malware. Here, two domain names “wednesdayride.net” and “wednesdaysmall.net” have been used as an input to the trained classifier 123. The generated output of the system 120 was a cluster of the following domain names having the similarity score higher than 0.95:

TABLE 2

| Domain name | Similarity Score |
|---|---|
| sellought.net | 1.00 |
| wednesdayought.net | 1.00 |
| driveride.net | 0.99 |
| sellride.net | 0.99 |
| forcesmall.net | 0.98 |
| weaksmall.net | 0.98 |
| leastmarry.net | 0.97 |

### EXAMPLE 3

The system and method for correlation of domain names described herein was used to identify an advertisement exchange network. In this example, the domain name “ad4game.com” was used as an input to the trained classifier 123. The training set of domain names has been also pre-processed by the data modifier 122 such that only domain names of the “AAAA” type were used in the training of the classifier 123. The generated output of the system 120 was a cluster of the following domain names having the similarity score higher than 0.99:

TABLE 3

| Domain name | Similarity Score |
|---|---|
| advantageglobalmarketing.com | 0.99 |
| affiliationworld.com | 0.99 |
| admexo.cz | 0.99 |
| admediaxtreme.com | 0.99 |
| supportingads.com | 0.99 |
| affiliationworld.com | 0.99 |
| admexo.cz | 0.98 |

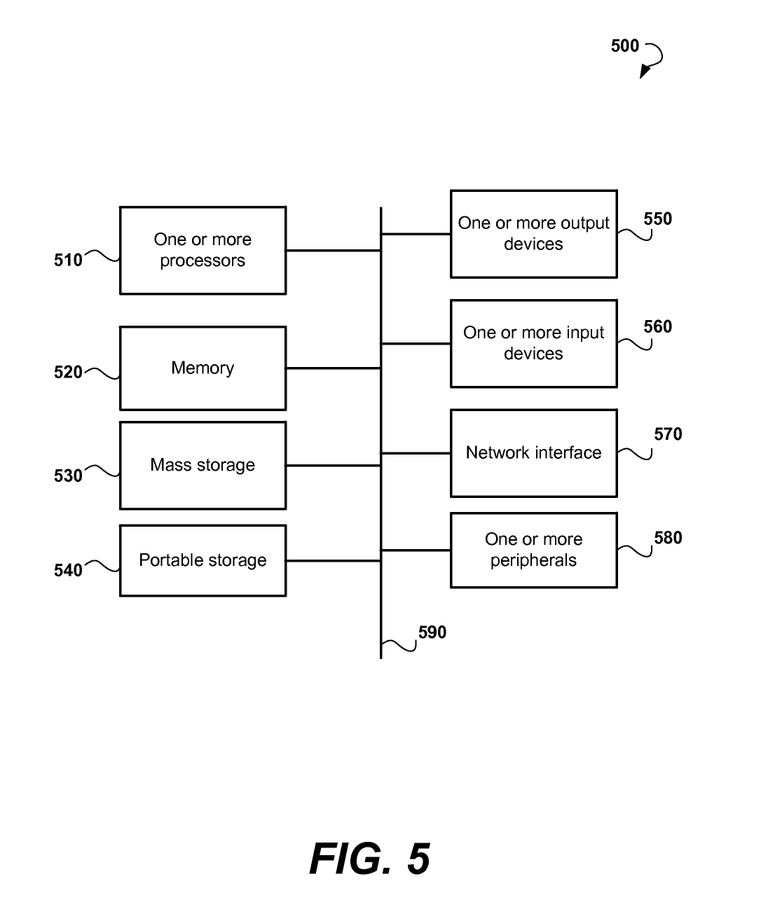

FIG. 5 illustrates an example computing system 500 that may be used to implement embodiments described herein. System 500 of may be implemented in the contexts of the likes of client device 105, the DNS server 110, and the system 120. The computing system 500 may include one or more processors 510 and memory 520. Memory 520 stores, in part, instructions and data for execution by processor 510. Memory 520 can store the executable code when the system 500 is in operation. The system 500 5 may further include a mass storage device 530, portable storage medium drive(s) 540, one or more output devices 550, one or more input devices 560, a network interface 570, and one or more peripheral devices 580.

The components shown in FIG. 5 are depicted as being connected via a single bus 590. The components may be connected through one or more data transport means. Processor 510 and memory 520 may be connected via a local microprocessor bus, and the mass storage device 530, peripheral device(s) 580, portable storage device 540, and network interface 570 may be connected via one or more input/output (I/O) buses.

Mass storage device 530, which may be implemented with a magnetic disk drive or an optical disk drive, is a non-volatile storage device for storing data and instructions for use by a magnetic disk or an optical disk drive, which in turn may be used by processor 510. Mass storage device 530 can store the system software for implementing embodiments described herein for purposes of loading that software into memory 520.

Portable storage medium drive(s) 540 operates in conjunction with a portable non-volatile storage medium, such as a compact disk (CD) or digital video disc (DVD), to input and output data and code to and from the computer system 500. The system software for implementing embodiments described herein may be stored on such a portable medium and input to the computer system 500 via the portable storage medium drive(s) 540.

Input devices 560 provide a portion of a user interface. Input devices 560 may include an alphanumeric keypad, such as a keyboard, for inputting alphanumeric and other information, or a pointing device, such as a mouse, a trackball, a stylus, or cursor direction keys. Additionally, the system 500 as shown in FIG. 5 includes output devices 550. Suitable output devices include speakers, printers, network interfaces, and monitors.

Network interface 570 can be utilized to communicate with external devices, external computing devices, servers, and networked systems via one or more communications networks such as one or more wired, wireless, or optical networks including, for example, the Internet, intranet, local area network (LAN), wide area network (WAN), cellular phone networks (e.g. Global System for Mobile (GSM) communications network, packet switching communications network, circuit switching communications network), Bluetooth radio, and an IEEE 802.11-based radio frequency network, among others. Network interface 570 may be a network interface card, such as an Ethernet card, optical transceiver, radio frequency transceiver, or any other type of device that can send and receive information. Other examples of such network interfaces may include Bluetooth®, 3G, 4G, and WiFi® radios in mobile computing devices as well as a Universal Serial Bus (USB).

Peripherals 580 may include any type of computer support device to add additional functionality to the computer system. Peripheral device(s) 380 may include a modem or a router.

The components contained in the computer system 500 are those typically found in computer systems that may be suitable for use with embodiments described herein and are intended to represent a broad category of such computer components that are well known in the art. Thus, the computer system 500 can be a personal computer (PC), hand held computing device, telephone, mobile computing device, workstation, server, minicomputer, mainframe computer, or any other computing device. The computer can also include different bus configurations, networked platforms, multi-processor platforms, and so forth. Various operating systems (OS) can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the example embodiments. Those skilled in the art are familiar with instructions, processor(s), and storage media.

It is noteworthy that any hardware platform suitable for performing the processing described herein is suitable for use with the example embodiments. The terms “computer-readable storage medium” and “computer-readable storage media” as used herein refer to any medium or media that participate in providing instructions to a Central Processing Unit (CPU) for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire, and fiber optics, among others, including the wires that include one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-read-only memory (ROM) disk, DVD, any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Thus, methods and systems for correlation of domain names have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense. There are many alternative ways of implementing the present technology. The disclosed examples are illustrative and not restrictive.

What is claimed is:

1. A computer-implemented method for correlating domain names, the method comprising:
receiving Domain Name System (DNS) data associated with a plurality of domain names;
based on the DNS data, generating multidimensional vectors, wherein each of the domain names is associated with one of the multidimensional vectors;
calculating similarity scores for each pair of the plurality of domain names based on a comparison of corresponding multidimensional vectors; and
based on the similarity scores, clustering one or more sets of domain names selected from the plurality of domain names such that a difference between the similarity scores corresponding to each pair of the domain names in each of clusters being below a predetermined threshold.

2. The method of claim 1, further comprising:
receiving a correlation request associated with a target domain name;
determining that the target domain name is included in a dictionary, wherein the dictionary includes the plurality of domain names associated with the multidimensional vectors; and
based on the determination that the target domain name is included in the dictionary, selecting a cluster associated with the target domain name.

3. The method of claim 1, further comprising:
receiving a correlation request associated with a target domain name;
determining that the target domain name is not included in a dictionary, wherein the dictionary includes the plurality of domain names associated with the multidimensional vectors;
ascertaining DNS data associated with the target domain name;
generating a multidimensional vector for the target domain name;
calculating similarity scores between the multidimensional vector for the target domain name and the multidimensional vectors of the plurality of the domain names in the dictionary; and
assigning the target domain name to a cluster based on the calculation.

4. The method of claim 1, further comprising:
training a classifier using the DNS data, wherein the classifier is configured to convert each of the domain names into one of the multidimensional vectors;
wherein the DNS data is associated with a plurality of DNS queries, and wherein the DNS data comprises, for each of the DNS queries, an Internet Protocol (IP) address of a client created a DNS request, a time stamp of the DNS request, a DNS query name, and a DNS query type.

5. The method of claim 4, wherein the training of the classifier comprises performing a forward propagation process to obtain a dictionary of the domain names with corresponding multidimensional vectors.

6. The method of claim 4, further comprising: grouping the DNS queries by IP addresses of clients.

7. The method of claim 4, further comprising: sorting the DNS queries by the time stamp.

8. The method of claim 1, further comprising: filtering the DNS data by removing DNS queries of predetermined types.

9. The method of claim 8, wherein the predetermined types of DNS queries include: DNS queries associated with malicious attacks, Address and Routing Parameter Area (ARPA) queries, and same DNS queries that appear less than a predetermined number of times in the training data.

10. The method of claim 1, wherein the receiving the DNS data associated with the plurality of domain names comprises collecting the DNS queries from multiple Internet Service Providers (ISPs) for a predetermined period of time, wherein the predetermined period of time is between about 1 minute and about 24 hours.

11. The method of claim 1, wherein the multidimensional vectors of the domain names include numeric representation vectors that reflect semantic similarities between the domain names.

12. The method of claim 1, further comprising: selecting the pairs of the plurality of domain names based on a skip-gram model.

13. The method of claim 1, further comprising: ranking two or more of the domain names in at least one of the clusters to create a ranked list of the domain names.

14. The method of claim 1, wherein each of the clusters of the domain names reflects operational behavior of the domain names in the cluster.

15. The method of claim 1, further comprising: projecting the multidimensional vectors onto two-dimensional (2D) space by performing a dimension reduction technique.

16. The method of claim 15, further comprising: visualizing at least one of the clusters of the domain names via a user graphical interface by displaying graphical representations of the multidimensional vectors projected onto the 2D space.

17. The method of claim 16, wherein the visualizing comprises displaying domain name maps, wherein each of the domain name maps is associated with an individual graphical representation such that the domain name maps are visually different from each other.

18. The method of claim 1, further comprising:
receiving DNS data associated with a plurality of domain names having trusted categorization data;
based on the DNS data, generating multidimensional vectors, wherein each of the domain names having the trusted categorization data is associated with one of the multidimensional vectors;
receiving at least one domain name with no categorization data or having untrusted categorization data;
generating a multidimensional vector of the at least one domain name with no categorization data or having untrusted categorization data;
calculating similarity scores between the multidimensional vector of the at least one domain name with no categorization data or having untrusted categorization data and each of the multidimensional vectors associated with the domain names having trusted categorization data; and
based on the similarity scores, assigning a category to the at least one domain name with no categorization data or having untrusted categorization data.

19. A computer-implemented system comprising at least one processor and a memory storing processor-executable codes, wherein the at least one processor is configured to:
receive Domain Name System (DNS) data associated with a plurality of domain names;
based on the DNS data, generate multidimensional vectors, wherein each of the domain names is associated with one of the multidimensional vectors;
calculate similarity scores for each pair of the plurality of domain names based on comparison of corresponding multidimensional vectors; and
based on the similarity scores, cluster one or more sets of domain names selected from the plurality of domain names such that a difference between the similarity scores corresponding to each pair of the domain names in each of clusters being below a predetermined threshold.

20. A non-transitory processor-readable medium having instructions stored thereon, which when executed by one or more processors, cause the one or more processors to implement a method, comprising:
receiving Domain Name System (DNS) data associated with a plurality of domain names;
based on the DNS data, generating multidimensional vectors, wherein each of the domain names is associated with one of the multidimensional vectors;
calculating similarity scores for each pair of the plurality of domain names based on comparison of corresponding multidimensional vectors; and
based on the similarity scores, clustering one or more sets of domain names selected from the plurality of domain names such that a difference between the similarity scores corresponding to each pair of the domain names in each of clusters being below a predetermined threshold.
